(19) United States
(12) Patent Application Publication
(10) Pub. No.: US 2011/0309640 A1
(43) Pub. Date: Dec. 22, 2011

(54) Lock device

(75) Inventor: Junichi Matsubara, Utsunomiya-shi (JP)

(73) Assignee: NIFCO INC., Yokohama-shi (JP)

(21) Appl. No.: 13/067,562

(22) Filed: Jun. 9, 2011

(30) Foreign Application Priority Data
Jun. 9, 2010 (JP) 2010-131829

(51) Int. Cl. E05C 1/12; E05C 1/08

(52) U.S. Cl. 292/159; 292/157

(57) ABSTRACT

A lock device locks a lid of a glove box and the like, and prevents half-latching of locking. When a lid starts closing, a left lock rod is driven to a right side, and a left lock arm turns counterclockwise against a spring force of a lock arm spring so as to start fitting into a catch hole of a catch on a left side. When the left lock rod is further driven to the right side, the left lock rod is completely fitted into the catch hole in a state wherein a lock claw of the left lock arm comes to a horizontal state. When the left lock rod is driven to the right side up to a final position, the left lock arm slightly moves to the right side. However, even in this state, the catch and the left lock arm maintain a sufficient engagement state.

### BACKGROUND OF THE INVENTION AND RELATED ART STATEMENT

The present invention relates to a lock device locking a lid of a glove box and the like, and more specifically, relates to a technology preventing half-latching of locking.

In an instrument panel of an automobile, in order for a passenger to store a small article, a document (for example, an automobile inspection certificate), or the like, in many cases, a glove box is disposed in a lower portion on a passenger seat side. As the glove box, a lid type and a unit type are generally employed, and a lid-type glove box comprises a glove box main body installed in the instrument panel and a lid covering a glove box opening of the instrument panel. Usually, in the lid, a mobile lock device comprising a lock piece, a spring, a lock release mechanism, and the like, is additionally provided. The lock piece is engaged with a locking hole formed in the instrument panel or the glove box main body, so that the lid is retained in a closed state. In the lock device, there is also the lock device which includes one lock piece in a center. However, a lock device, which includes lock pieces at ends of right-and-left lock arms so as to engage the lock pieces with corresponding locking holes to carry out an assured closing of the lid, has been increased. (See Japanese Unexamined Patent Application Publication No. 2006-104771: Patent Document 1)

In the glove box comprising the lock device of the above-mentioned Patent Document 1, due to bending of the lid and the like, the half-latching of the locking may occur. For example, as shown in FIGS. 13(a), 13(b), when a lid 12 is closed, in a case when a passenger applies a force F (shown by an arrow) only to a right end of the lid 12, since an engagement resistance (i.e., an urging force allowing lock claws 72L, 72R to protrude from the lid 12, or a frictional force between the lock claws 72L, 72R and right-and-left catches 21, 22) also exists, the lid is bent. Accordingly, the half-latching may occur, wherein only the right lock claw 72R engages the catch 22, and the left lock claw 72L does not engage the catch 21. In this case, the passenger is required to close the lid 12 by applying a force to a left side of the lid 12 again, and additionally, if the passenger drives an automobile while the passenger does not notice the half-latching of the locking, due to an impact when the automobile runs over an uneven path and the like, the right lock claw 72R and the catch 22 disengage, so that the lid 12 opens, and an article stored in the glove box 10 might come out.

An object of the present invention is to prevent the half-latching of the locking in the lock device locking the lid of the glove box and the like in consideration of the above-mentioned background.

Further objects and advantages of the invention will be apparent from the following description of the invention.

### SUMMARY OF THE INVENTION

A lock device according to a first invention is a device provided in a storage device comprising a storage device main body, provided for storing an article, and a lid closing an opening of the storage device, and locking the lid in a closed state. In the storage device main body, first and second catch portions are respectively provided on both end sides in a longitudinal direction. The lid includes first and second lock pieces respectively protruding from both end sides of the longitudinal direction of the lid, and respectively fitted into the first and second catch portions; urging means urging the first and second lock pieces in a lock release direction; and lock-piece drive means allowing the first and second lock pieces to be respectively fitted into the first and second catch portions by abutting against the storage device main body. As for the lock-piece drive means, at a time of a closing operation of the lid, after the first and second lock pieces respectively face the first and second catch portions, the first and second lock pieces are respectively fitted into the first and second catch portions.

Also, as for a second invention, in the lock device according to the first invention, the lock-piece drive means abuts against an approximate center of the longitudinal direction of the storage device main body.

Also, as for a third invention, in the lock device according to the first or the second invention, the first and second lock pieces are supported in the lid. Also, by turning, the first and second lock pieces are fitted into or disengaged from the first and second catch portions. The lock-piece drive means comprises a drive piece displaced by abutting against the striker; a first slider sliding in one direction by being driven by the drive piece, and allowing the first lock piece to rotate in a direction where the first lock piece is fitted into the first catch portion; and a second slider sliding in the other direction when the first slider moves in one direction by being connected to the first slider through a gear, and allowing the second lock piece to rotate in a direction where the second lock piece is fitted into the second catch portion.

Also, as for a fourth invention, in the lock device according to the third invention, the first lock piece is housed in a first holder formed in the lid, and after the first lock piece is rotated with a predetermined angle by the first slider, the first lock piece is retained in an un-rotatable state by the first holder, and the second lock piece is housed in a second holder formed in the lid, and after the second lock piece is rotated with a predetermined angle by the second slider, the second lock piece is retained in the un-rotatable state by the second holder.

Also, as for a fifth invention, in the lock device according to the third or the fourth invention, on at least one of the drive piece and the first slider, an inclined cam face for a slide drive is formed. In either one of the drive piece or the first slider, the other side locking portion, which engages one side locking portion formed in the other of the drive piece or the first slider, is provided. After the first and second lock pieces are respectively fitted into the first and second catch portions, one side locking portion and the other side locking portion are engaged.

Also, as for a sixth invention, in the lock device according to the first to fifth inventions, lock release means allowing at least one of the first and second lock pieces to operate in a lock release direction, is provided.

According to the first invention, at the time of the closing operation of the lid, since the lock pieces are fitted into the catch portions after the lock pieces face the catch portions, half-latching due to an engagement resistance can be prevented. Also, according to the second invention, since the lock-piece drive means abut against the approximate center of the longitudinal direction of the storage device main body, bending of the lid can be prevented, so that the half-latching can be prevented further reliably. Also, according to the third invention, since the lock pieces turn and are fitted into the catch portions, closing of the lid can be carried out further reliably. Also, according to the fourth invention, even in a case when a force in an open direction is applied, the lid can be prevented from opening inappropriately. Also, according to the fifth invention, an engagement between the drive piece and the first slider is carried out stably, and the lid in the closed state can be prevented from opening inappropriately. Also, according to the sixth invention, the lid can be opened with a single touch of a finger.

### BRIEF DESCRIPTION OF THE DRAWINGS

FIG. 1 is a perspective view showing a vehicle interior front portion of an automobile according to an embodiment;

FIG. 2 is a plan view showing a layout of a lock device for a glove box thereof;

FIG. 3 is an exploded perspective view showing the glove box thereof;

FIG. 4 is an exploded perspective view showing a lock mechanism thereof;

FIGS. 5(a), 5(b) are perspective views showing a lock-rod drive portion thereof;

FIGS. 6(a), 6(b), 6(c) are perspective views showing a lock-arm drive portion thereof;

FIGS. 7(a), 7(b), 7(c) are explanatory drawings showing an operation when the lock-arm drive portion is open;

FIGS. 8(a), 8(b), 8(c) are explanatory drawings showing an operation when the lock-arm drive portion is closed;

FIGS. 9(a), 9(b) are explanatory drawings showing an opening operation of a lid for the glove box;

FIGS. 10(a), 10(b) are explanatory drawings showing a closing operation of the lid for the glove box;

FIG. 11 is a plan view showing the layout of the lock device for the glove box according to an example in which one portion is transformed;

FIGS. 12(a), 12(b), 12(c) are explanatory drawings showing an operation when a lock-pin drive portion according to the example in which one portion is transformed is closed; and

FIGS. 13(a), 13(b) are explanatory drawings showing a problem of a conventional device.

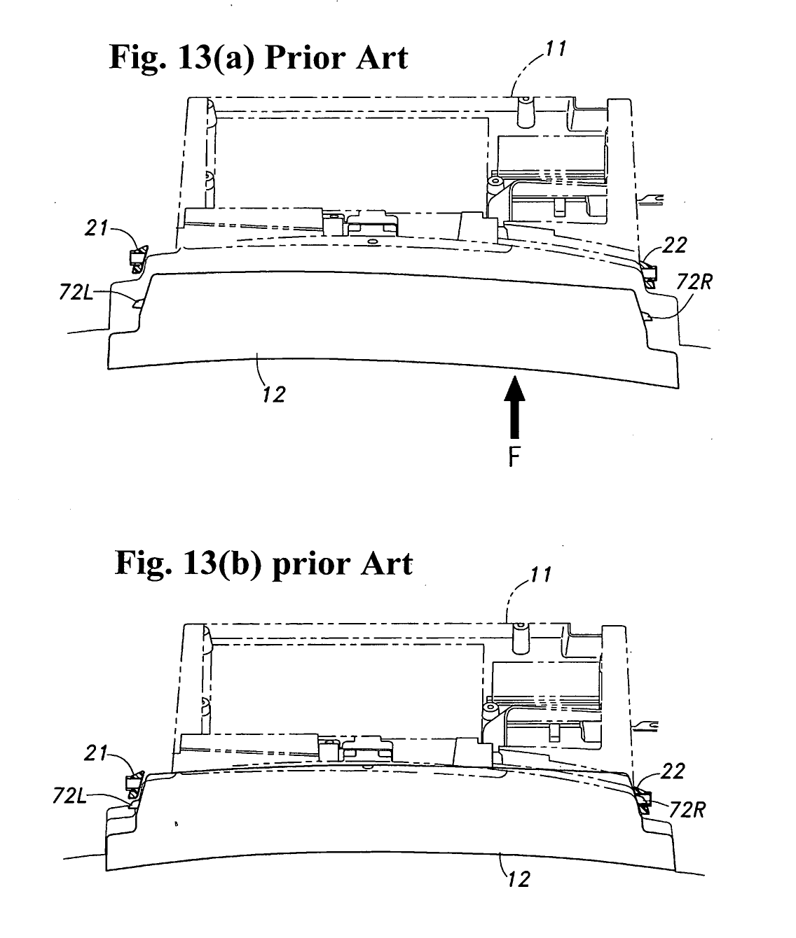

### DETAILED DESCRIPTION OF PREFERRED EMBODIMENTS

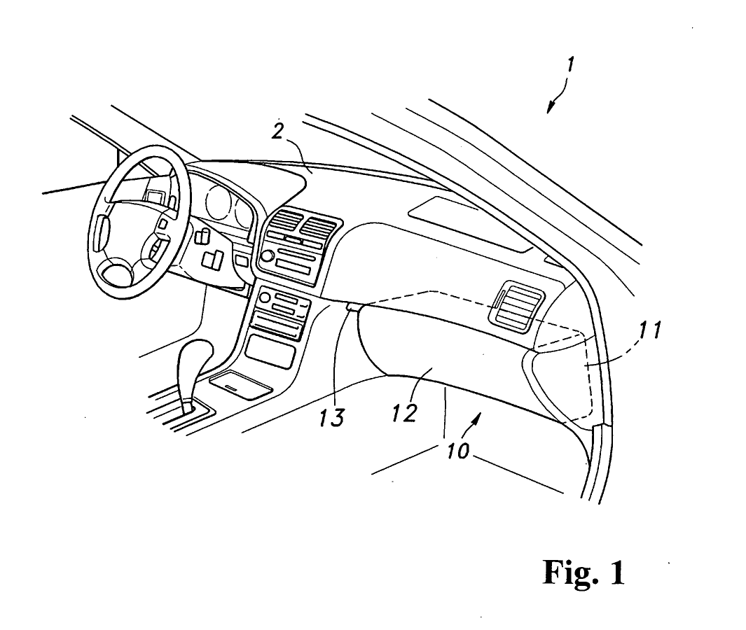

Hereinafter, an embodiment in which the present invention is applied to a glove box for an automobile, and an example in which one portion is modified will be explained in detail with reference to drawings. Incidentally, as for an explanation of the embodiment or the example in which one portion is modified, an oblique right side in FIG. 1 will be a right side; an oblique left side in FIG. 1 will be a back side; and a lower side in FIG. 1 will be a bottom side.

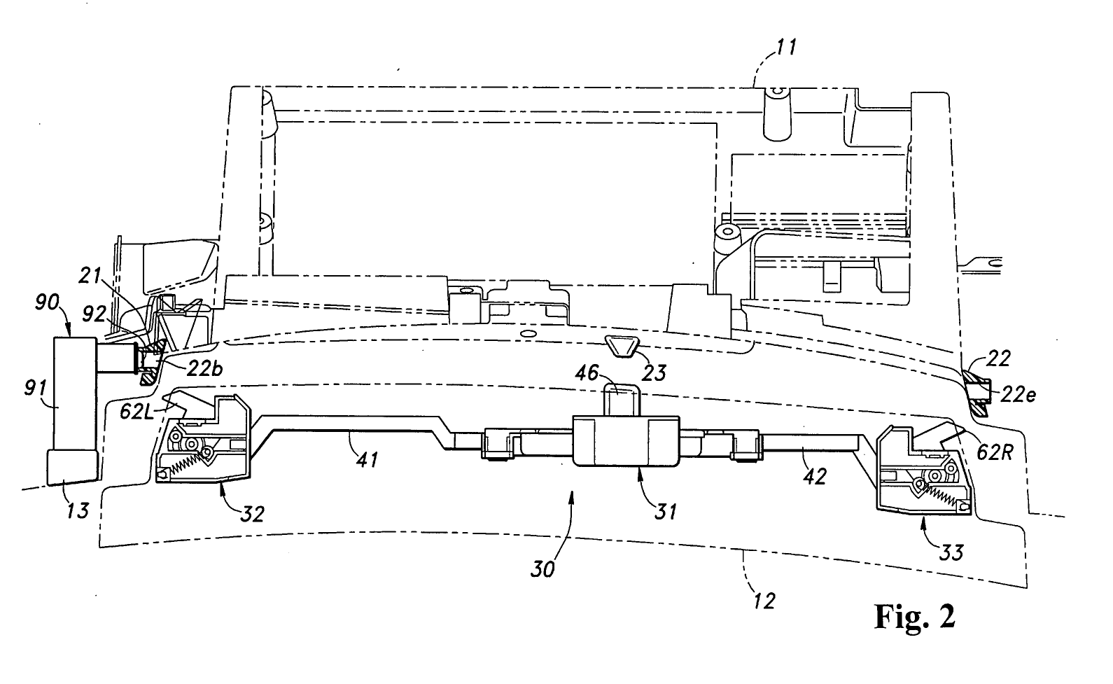

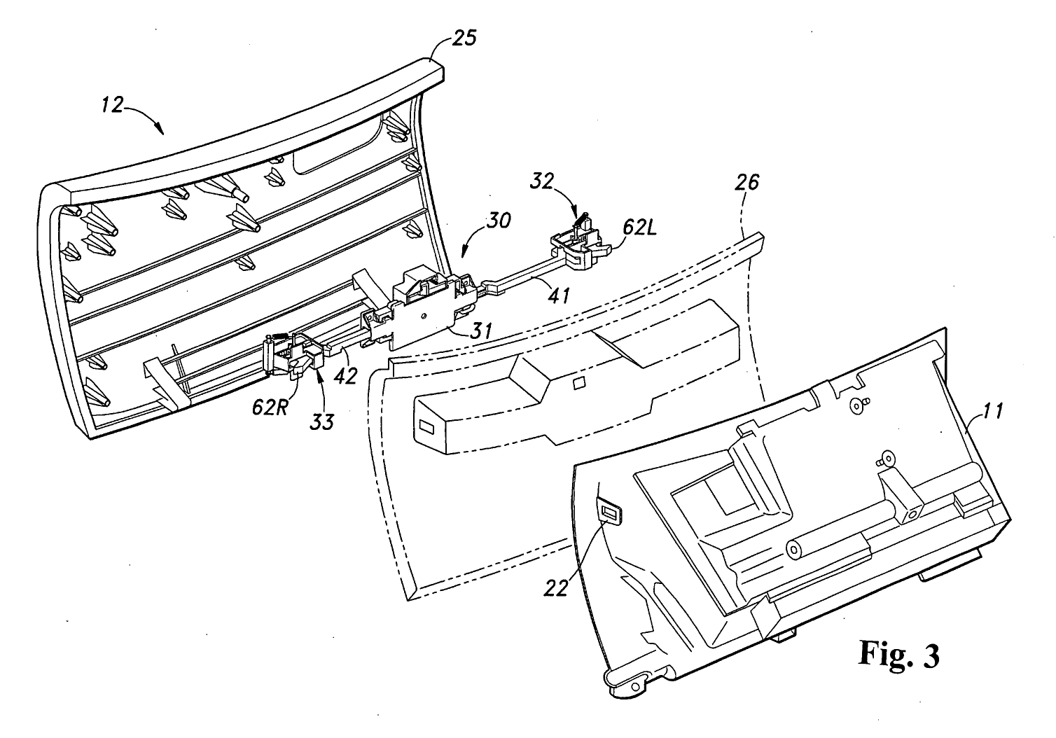

As shown in FIG. 1, an automobile 1 according to the present embodiment is a four-door sedan with the steering wheel on the left side, and comprises a lid-type glove box 10 on a passenger-side lower portion of an instrument panel 2. As also shown in FIGS. 2, 3, the glove box 10 comprises a glove box main body 11 housed in the instrument panel 2, and a lid 12 with a downward hinge. In the instrument panel 2, a lock release button 13 is provided at a side of a center console 3, and by operating (pushing in) the lock release button 13, the lid 12 opens.

As shown in FIG. 2, in the glove box main body 11, catches 21, 22 including catch holes 21a, 22a are respectively fitted on right-and-left side faces. Also, in an approximate center portion of an upper end thereof, a striker 23 is projected toward a backward direction. On the other hand, as shown in FIG. 3, the lid 12 is made by fastening/integrating an outer panel 25 forming a surface side (vehicle interior side) with an inner panel 26 forming a reverse face side, and a lock mechanism 30 is housed in a space formed between both panels 25, 26. The lock mechanism 30 comprises a lock-rod drive portion 31 placed in an approximate center, and right-and-left lock-arm drive portions 32, 33 placed on right and left ends. The lock-rod drive portion 31 and the lock-arm drive portions 32, 33 are connected by right-and-left lock rods 41, 42.

### <Lock-Rod Drive Portion>

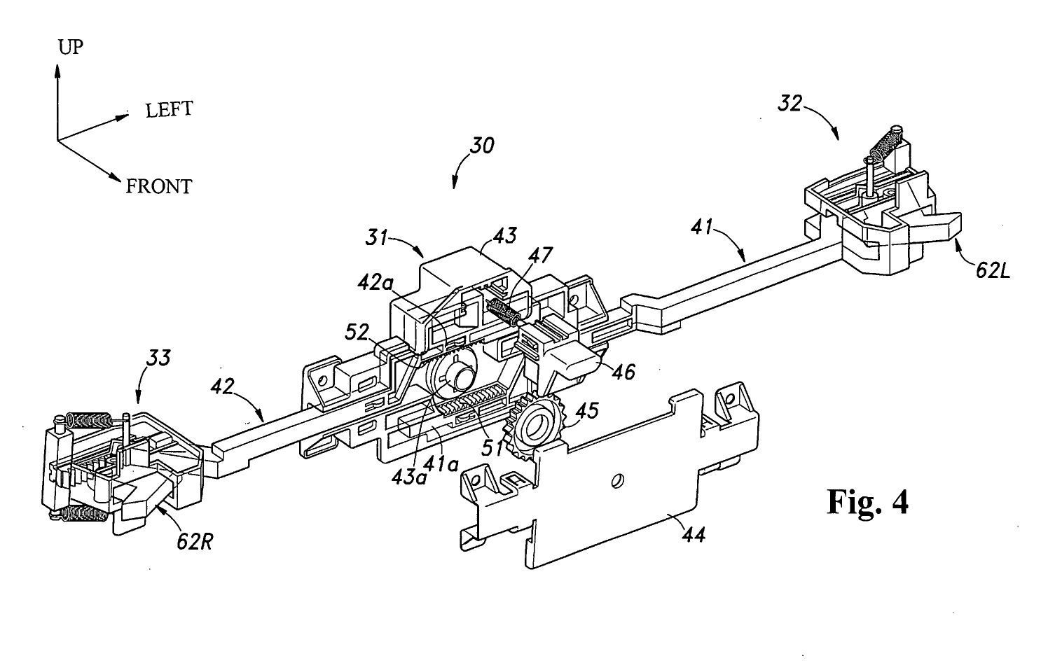

As shown in FIG. 4, the lock-rod drive portion 31 has, as an outline, a housing 43 which is fastened to the outer panel 25, and a cover 44. The lock-rod drive portion 31 houses base end sides (center sides) 41a, 42a of the right-and-left lock rods 41, 42; a synchronous gear 45 allowing the right-and-left lock rods 41, 42 to drive synchronously; a drive piece 46 driving the right lock rod 42 to the left side; and a return spring 47 urging the drive piece 46 forward.

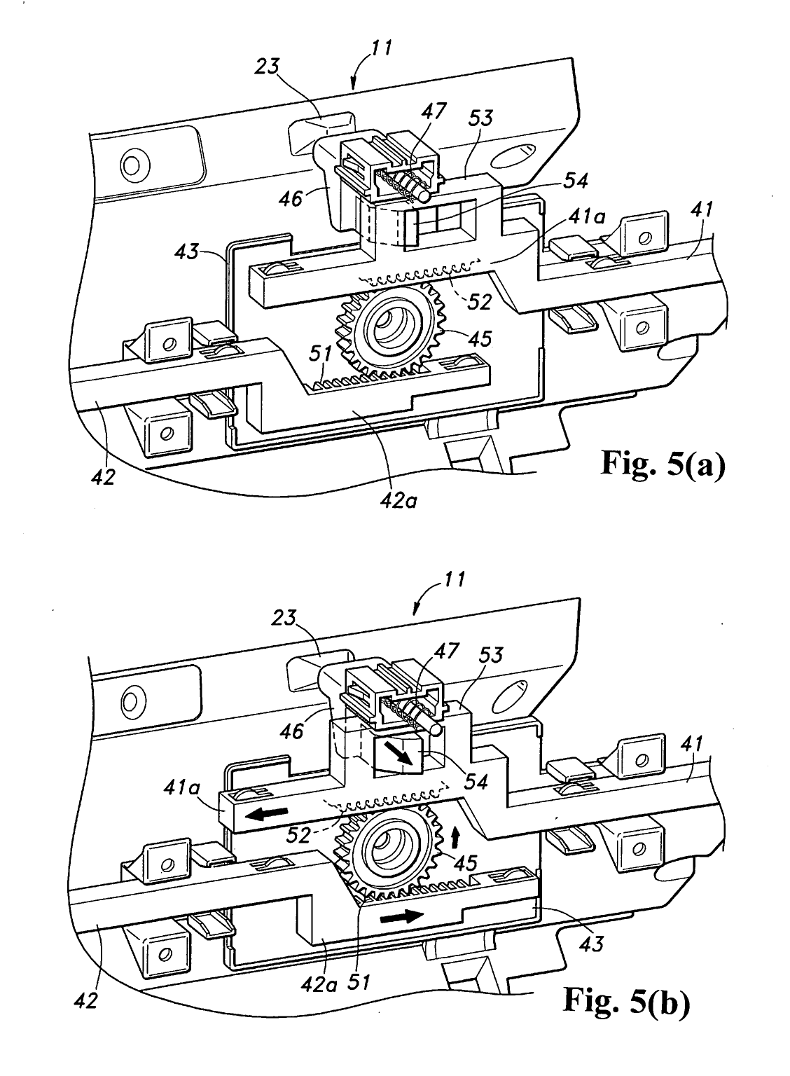

As shown in FIGS. 5(a), 5(b), the base end side 41a of the left lock rod 41 is positioned on a lower side of the synchronous gear 45, and a rack 51 engaging with the synchronous gear 45 is formed on an upper surface thereof. Also, the base end side 42a of the right lock rod 42 is located on the upper side of the synchronous gear 45, and a rack 52 engaging with the synchronous gear 45 is formed on a lower surface thereof. The synchronous gear 45 is rotatably supported by a supporting boss 43a projected from a front surface of the housing 43, and drives the left lock rod 41 to the right side when the right lock rod 42 has moved to the left side.

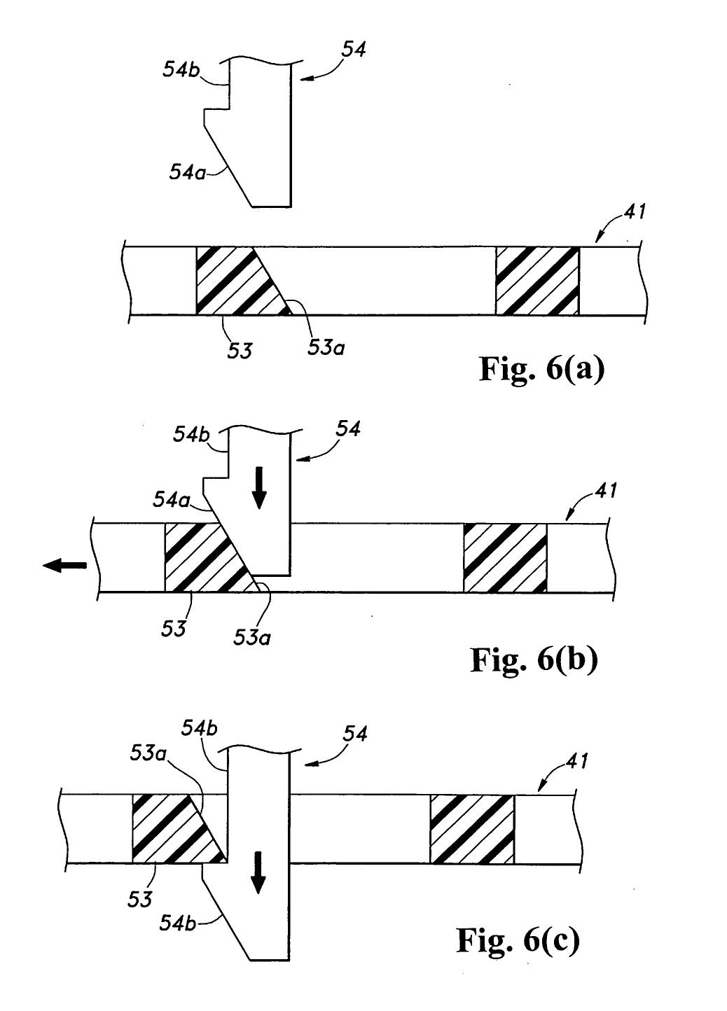

As shown in FIGS. 5(a), 5(b), on an upper portion of the left lock rod 41, a short frame-like driven piece 53 is projected, and a drive projection 54, formed in a front end lower portion of the drive piece 46, is fitted into an inside of this driven piece 53. As shown in FIG. 6(a), the driven piece 53 and the drive projection 54 respectively include inclined cam faces 53a, 54a, and as shown in FIG. 6(b), both inclined cam faces 53a, 54a relatively slide by closing the lid 12, and the driven piece 53 (i.e., the right lock rod 42) moves to the left side. Incidentally, in the drive projection 54, a step portion 54b is formed in front of the inclined cam face 54a, and when the drive projection 54 is completely retracted accompanied by the closing of the lid 12, as shown in FIG. 6(c), this step portion 54b is locked in a front edge of the driven piece 53.

In a case of the present embodiment, since the right-and-left lock-arm drive portions 32, 33 are symmetric, only the structure of the left lock-arm drive portion 32 will be explained.

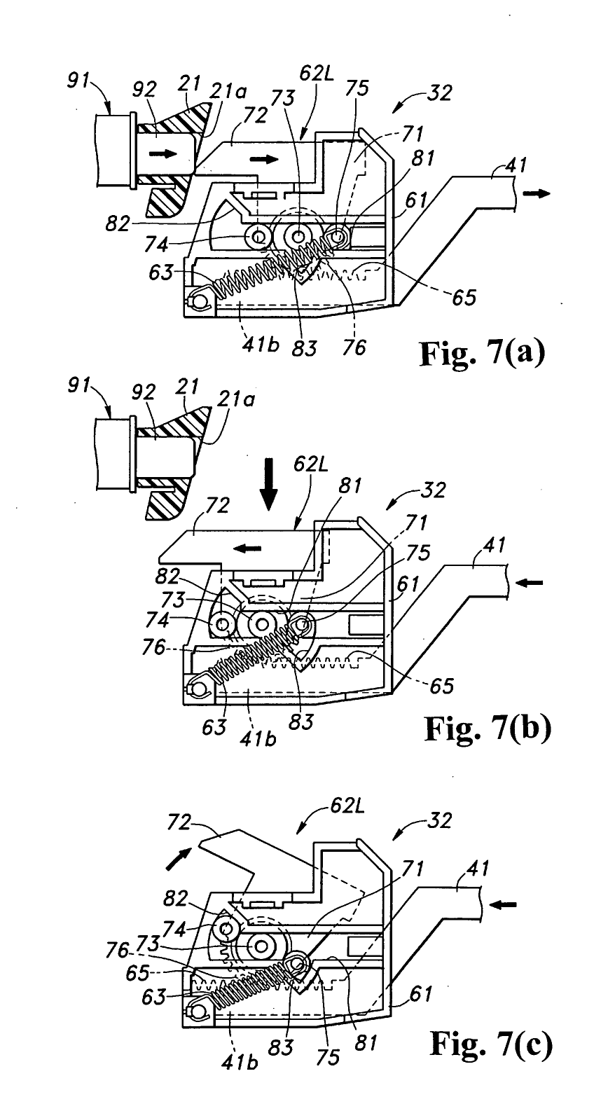

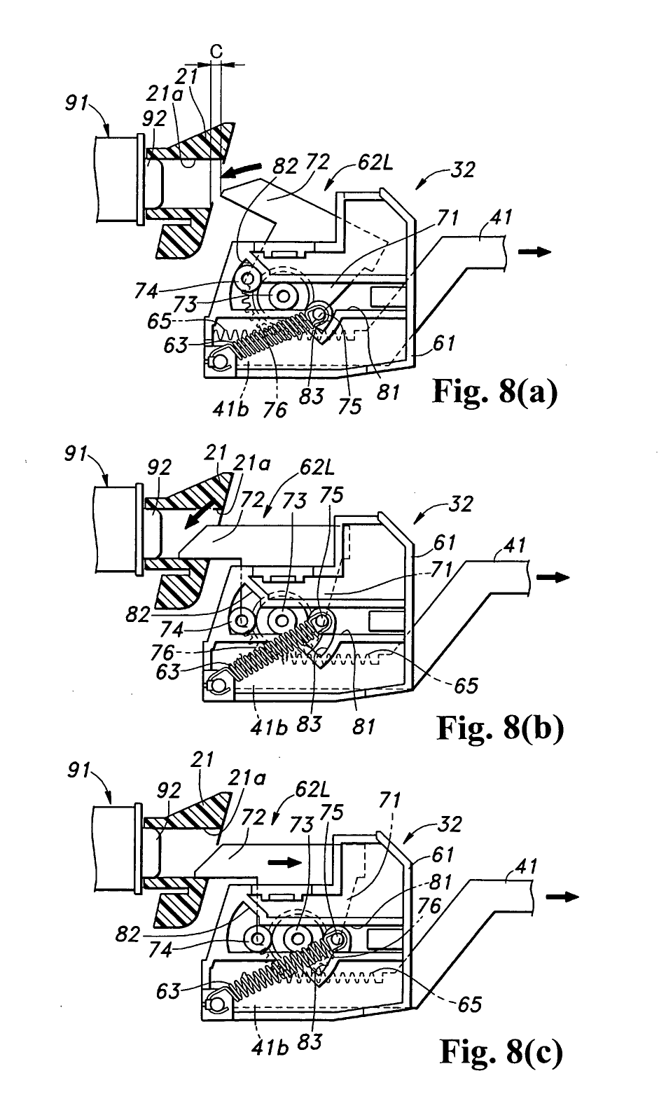

As shown in FIGS. 7(a) to 8(c), the left lock-arm drive portion 32 has an outline of a lock arm case 61 fastened to the outer panel 25, and houses an end side (left end side) 41b of the left lock rod 41 and a left lock arm 62L. Also, on the lock arm case 61 and the left lock arm 62L, a pair of lock arm springs 63 urging the left lock arm 62L to the left side is bridged. The end side 41b of the left lock rod 41 is located on a lower side of the left lock arm 62L, and a rack 65 is formed on an upper surface of the end side 41b.

The left lock arm 62L has an approximate L shape wherein a lock claw 72 is projected from a left side of an upper portion of a base portion 71. Also, the left lock arm 62L includes a pivot axis 73 which becomes a turning center, and a right-and-left pair of first and second bosses 74, 75 sandwiching the pivot axis 73, on a base portion thereof. Also, on an outer circumference of a lower portion of the base portion 71, a sector gear 76 is formed, and this sector gear 76 is engaged with the rack 65 of the left lock arm 62L. Incidentally, in the above-mentioned lock arm spring 63, one end thereof is latched to the second boss 75.

The lock arm case 61 comprises a slot 81 extended in a right-and-left direction, and first and second recesses 82, 83 respectively formed in an upper portion and a lower portion of the slot 81. The left lock arm 62L moves to right and left in a state wherein the pivot axis 73 and the first and second bosses 74, 75 are retained in the slot 81. Also, on a left end, the first and second bosses 74, 75 are respectively fitted into the first and second recesses 82, 83, so that the left lock arm 62L can be turned clockwise at a center of the pivot axis 73 with a predetermined angle. Incidentally, as shown in FIGS. 7(c), 8(a), in a state wherein the lock arm spring 63 is shrunk the most, the first and second bosses 74, 75 are respectively fitted into the first and second recesses 82, 83 so as to become a shape in which the lock claw 72 is bounced on the upper side. Incidentally, in a state shown in FIG. 8(a), a predetermined gap C (for example, approximately 1 to 2 mm) exists in a right-and-left direction between a right end (a back edge of the catch hole 21a) of the catch 21 and a left end of the lock claw 72.

As shown in FIG. 2, the lock release button 13 constitutes a lock release actuator 91 placed inside the instrument panel 2, and also a lock release mechanism 90. The lock release actuator includes a push rod 92 proceeding and receding inside the catch 21 on a left side. If the lock release button 13 is pressed by a passenger, as shown in FIG. 7(a), the push rod 92 proceeds into the catch 21 on the left side, and slightly protrudes into the glove box main body 11.

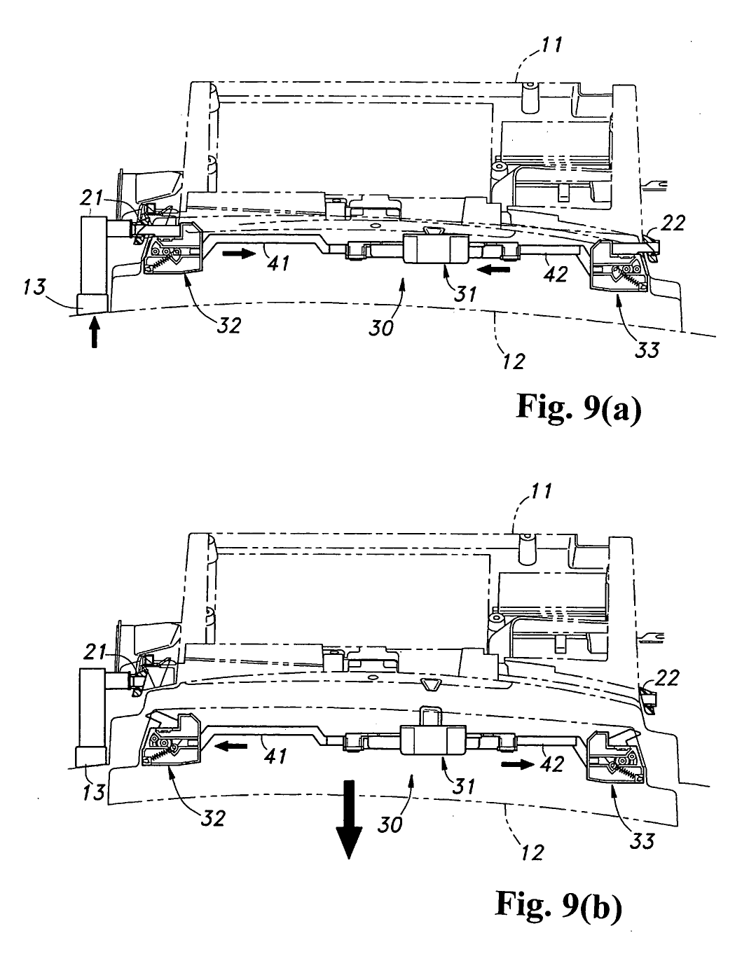

In a case when a passenger opens the lid 12 of the glove box 10 which is in a closed state, as shown in FIG. 9(a), the lock release button 13 is pressed by one's finger. Then, as shown in FIG. 7(a), the push rod 92 of the lock release actuator 91 proceeds into the catch hole 21a of the catch 21 on the left side, and pushes the lock claw 72 of the left lock arm 62L out of the catch hole 21a to the right side. Thereby, with the left lock arm 62L, the left lock rod 41 also integrally moves to the right side, and as shown in FIG. 5(b), the right lock rod 42 is driven to the left side through the synchronous gear 45. As a result, the lock claw 72 of a right lock arm 62R also slips out of the catch hole 22a on the right side, and as shown in FIG. 9(b), the lid 12 starts to open under one's own weight.

In the left lock-arm drive portion 32, when the lid 12 starts to open, and an urging force of the push rod 92 stops operating, as shown in FIG. 7(b), the left lock arm 62L and the left lock rod 41 start to move to the left side by a spring force of the lock arm spring 63. Then, when the left lock arm 62L moves up to a left end, as shown in FIG. 7(c), the first and second bosses 74, 75 are respectively fitted into the first and second recesses 82, 83; the left lock arm 62L turns clockwise; and the lock claw 72 is bounced on the upper side. Also, even in the right lock-arm drive portion 33, the right lock rod 42 moves to the right side by the same mechanism; the right lock arm 62R turns counterclockwise; and the lock claw 72 is bounced on the upper side. Incidentally, since the right lock rod 42 moves to the right side, in FIG. 6(c), an engagement between the step portion 54b of the drive projection 54 and the driven piece 53 is released, and by a spring force of the return spring 47, the drive piece 46 moves forward.

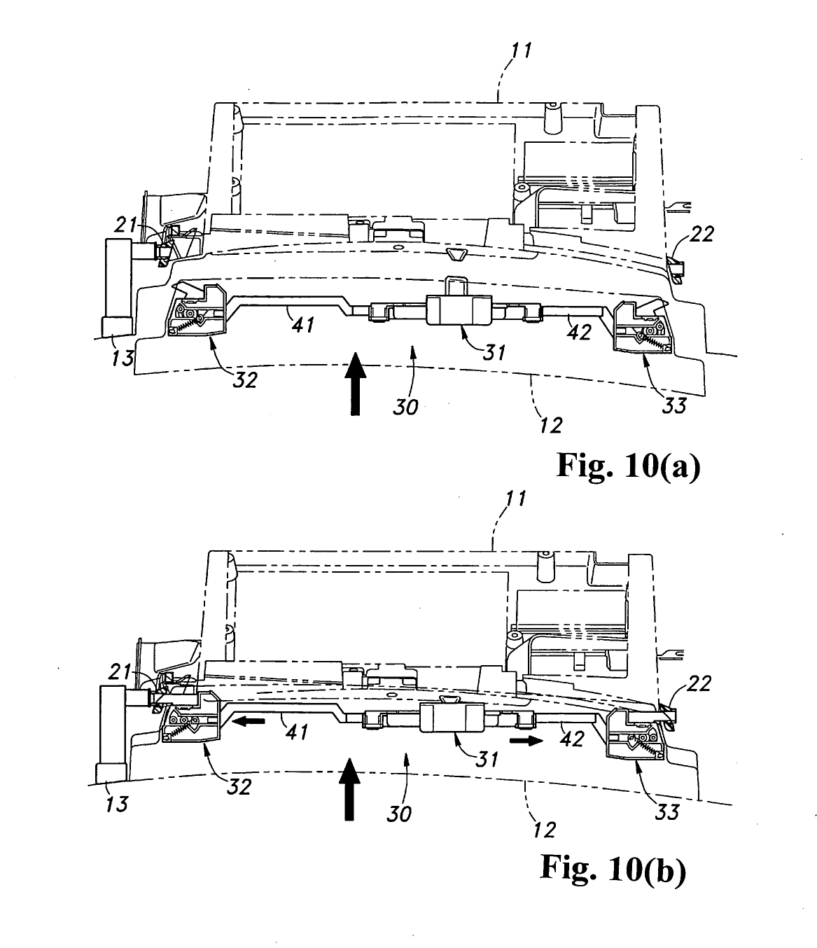

In a case when a passenger closes the lid 12 of the glove box 10 which is in an open state, as shown in FIG. 10(a), a rear face of the lid 12 is pressed forward by one's palm or finger. At this time, as shown in FIG. 8(a), since the above-mentioned gap C exists in the right-and-left direction between the end portion of the lock claw 72, which has been bounced on the upper side, and the catches 21, 22, when the lid 12 is closed, a smooth closing operation can be realized as shown in FIG. 10(b) without producing a resistance such as in a conventional device.

When the lid 12 starts to close, the drive piece 46 moves backward by abutting against the striker 23 of the glove box main body 11. Then, in the lock-rod drive portion 31, as shown in FIG. 6(b), the driven piece 53, and the inclined cam faces 53a, 54a of the drive projection 54 relatively slide, and the driven piece 53 (i.e., the right lock rod 42) moves to the left side. Thereby, the left lock rod 41 is driven to the right side through the synchronous gear 45, and as shown in FIG. 8(a), the left lock arm 62L turns counterclockwise against a spring force of the lock arm spring 63, and starts to be fitted into the catch hole 21a of the catch 21 on the left side.

As shown in FIG. 8(b), when the left lock rod 41 is further driven to the right side, the lock claw 72 of the left lock arm 62L in a horizontal state is completely fitted into the catch hole 21a. When the left lock rod 41 is driven to the right side up to a final position, the left lock arm 62L slightly moves to the right side. However, even in this state, the catch 21 and the left lock arm 62L maintain a sufficient engagement state. Incidentally, as shown in FIG. 6(c), when the lid 12 comes to a complete closed state, the step portion 54b of the drive projection 54 is locked in the front edge of the driven piece 53, so that a locked state of the lid 12 cannot be released inappropriately.

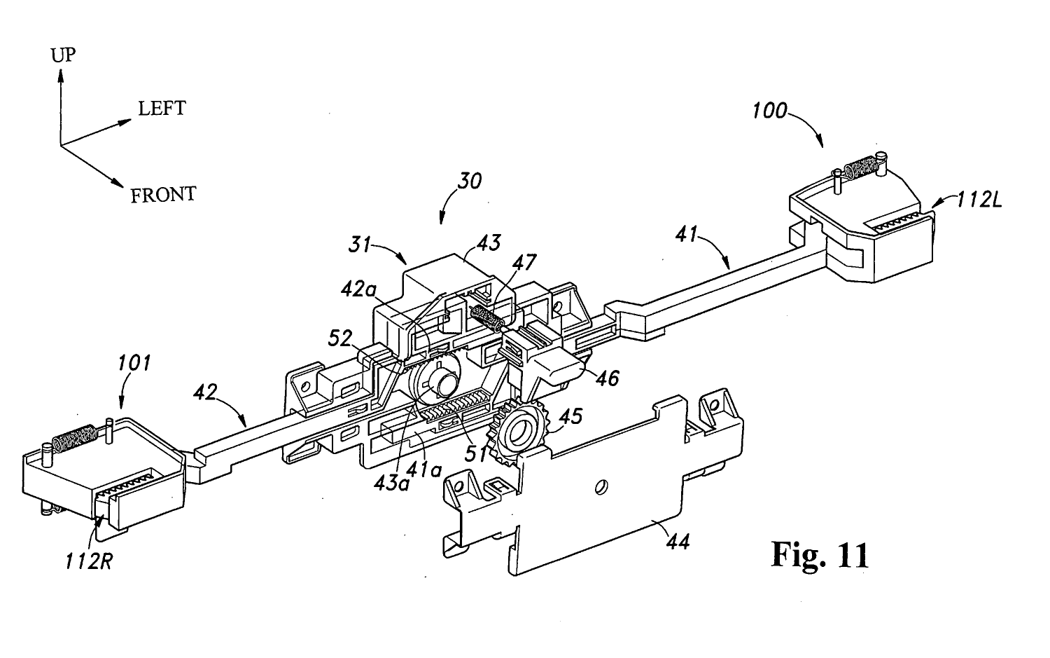

As shown in FIG. 11, the example in which one portion is transformed includes the same structure as that of the above-mentioned embodiment except that the example in which one portion is transformed includes right-and-left lock-pin drive portions 100, 101 in place of the lock-arm drive portions. Therefore, as for an explanation of the example in which one portion is transformed, only the lock-pin drive portions will be explained.

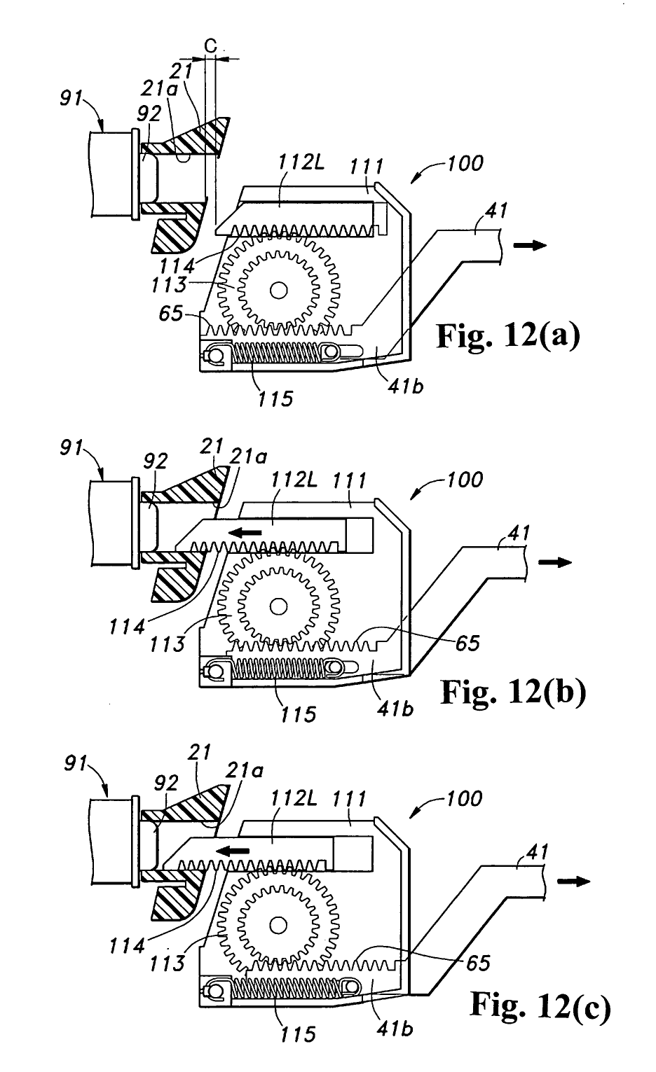

As shown in FIG. 12, the left lock-pin drive portion 100 has an outline of a lock pin case 111 which is fastened to the outer panel 25, and houses the end side (left end side) 41b of the left lock rod 41; a left lock pin 112L; and a drive gear 113. The drive gear 113 is turnably supported in the lock pin case 111, and engaged with the rack 65 formed on the upper surface of the end side 41b of the left lock rod 41, and a rack 114 formed on a lower surface of the left lock pin 112L. Also, in the lock pin case 111 and the left lock rod 41, a pair of lock rod springs 115, urging the left lock rod 41 to a left side, is bridged.

Hereinafter, as an example of a closed time of the lid 12, an operation of the example in which one portion is transformed will be explained.

In a case when a passenger closes the lid 12 of the glove box 10 which is in the open state, as in a case of the embodiment, the rear face of the lid 12 is pressed forward by one's palm or finger. At this time, as shown in FIG. 12(a), since the gap C exists in the right-and-left direction between end portions of the lock pins 112L, 112R, and the catches 21, 22, when the lid 12 is closed, a smooth closing operation can be realized without producing a resistance such as in the conventional device.

When the lid 12 starts to close, the drive piece 46 moves backward by abutting against the striker 23 of the glove box main body 11. Then, in the lock-rod drive portion 31, as shown in FIG. 6(b), the driven piece 53, and the inclined cam faces 53a, 54a of the drive projection 54 relatively slide, and the driven piece 53 (i.e., the left lock rod 41) moves to the left side. Thereby, the left lock rod 41 is driven to the right side through the synchronous gear 45, and as shown in FIG. 12(a), the left lock pin 112L moves to the left side through the drive gear 113, and starts to be fitted into the catch hole 21a of the catch 21 on the left side.

As shown in FIG. 12(b), when the left lock rod 41 is further driven to the right side, the left lock pin 112L is completely fitted into the catch hole 21a. When the left lock rod 41 is driven to the right side up to the final position, the left lock pin 112L further moves to the right side, and maintains a sufficient engagement state with the catch 21. Incidentally, as in the case of the embodiment, as shown in FIG. 6(c), when the lid 12 comes to the complete closed state, the step portion 54b of the drive projection 54 is locked in the front edge of the driven piece 53, so that the locked state of the lid 12 cannot be released inappropriately.

The explanation of the specific embodiment will be ended here. However, the embodiment of the present invention is not limited to the above-mentioned embodiments. For example, in the above-mentioned embodiment and the example in which one portion is transformed, although the present invention is applied to a lid lock mechanism of the glove box, the present invention can be naturally applied to other lock mechanisms such as a lid lock mechanism of a side pocket and the like. Also, in the above-mentioned embodiment and the example in which one portion is transformed, although the striker is provided in the glove box main body, the drive piece may be abutted against a planar portion of the glove box main body. Also, specific structures of the lock-rod drive portion, lock-arm drive portion, lock-pin drive portion, and the like can be modified appropriately according to a layout, manufacturing reasons, or the like provided that they do not exceed the subject of the present invention.

The disclosure of Japanese Patent Application No. 2010-131829, filed on Jun. 9, 2010, is incorporated in the application.

While the invention has been explained with reference to the specific embodiments of the invention, the explanation is illustrative and the invention is limited only by the appended claims.

What is claimed is:

1. A lock device provided in a storage device, comprising:
a storage device main body for storing an article, and a lid closing an opening of the storage device,
first and second catch portions respectively provided in two end sides of the storage device main body in a longitudinal direction thereof,
first and second lock pieces, respectively, protruding from two end sides of the lid in a longitudinal direction thereof to be fitted into the first and second catch portions,
an urging device associating with the first and second lock pieces to urge the first and second lock pieces in a lock release direction,
a lock-piece drive device associated with the first and second lock pieces so that the first and second lock pieces are respectively fitted into the first and second catch portions when abutting against the storage device main body,
wherein at a time of a closing operation of the lid, after the first and second lock pieces respectively face the first and second catch portions, the lock-piece drive device operates such that the first and second lock pieces are respectively fitted into the first and second catch portions.

2. A lock device according to claim 1, wherein the lock-piece drive device abuts against the storage device main body at about a center in the longitudinal direction thereof.

3. A lock device according to claim 1, wherein the first and second lock pieces are supported in the lid, and are fitted into or disengaged from the first and second catch portions by turning, and
the lock-piece drive device comprises:
a drive piece displaced by abutting against a striker;
a first slider sliding in one direction by being driven by the drive piece, and allowing the first lock piece to rotate in a direction where the first lock piece is fitted into the first catch portion; and
a second slider sliding in the other direction when the first slider moves in one direction by being connected to the first slider through a gear, and allowing the second lock piece to rotate in a direction where the second lock piece is fitted into the second catch portion.

4. A lock device according to claim 3, wherein the first lock piece is housed in a first holder formed in the lid, and after the first lock piece is rotated with a predetermined angle by the first slider, the first lock piece is retained in an un-rotatable state by the first holder, and
the second lock piece is housed in a second holder formed in the lid, and after the second lock piece is rotated with a predetermined angle by the second slider, the second lock piece is retained in the un-rotatable state by the second holder.

5. A lock device according to claim 3, wherein at least one of the drive piece and the first slider includes an inclined cam face for a slide drive, and
one of the drive piece and the first slider includes the other side locking portion, which engages one side locking portion formed in the other of the drive piece or the first slider, and after the first and second lock pieces are respectively fitted into the first and second catch portions, one side locking portion and the other side locking portion are engaged.

6. A lock device according to claim 1, further comprising a lock release device allowing at least one of the first and second lock pieces to operate in a lock release direction.
